(19) United States
(12) Patent Application Publication
(10) Pub. No.: US 2013/0326494 A1
(43) Pub. Date: Dec. 5, 2013

(54) SYSTEM AND METHOD FOR DISTRIBUTED PATCH MANAGEMENT

(71) Applicant: Yonesy F. NUNEZ, Allentown, PA (US)

(72) Inventor: Yonesy F. NUNEZ, Allentown, PA (US)

(21) Appl. No.: 13/562,829

(22) Filed: Jul. 31, 2012

Related U.S. Application Data
(60) Provisional application No. 61/654,419, filed on Jun. 1, 2012.

(51) Int. Cl. G06F 9/44; G06F 15/16

(52) U.S. Cl. 717/172

(57) ABSTRACT

A method and system for distributing patches (e.g., software patches) to network nodes in a peer-to-peer network. A plurality of network nodes may be designated or associated as server nodes. Each server node may be assigned to manage software patch distribution for a different zone, where each zone may include a different plurality of network nodes. Upon detecting a node in a zone to be a node in need of an update, a patch may be received from a patch source at the server node in the same zone as the node in need of the update. The patch may be transferred from the server node to the node in need of the update. The patch may be used to update the node in need of an update.

### PRIOR APPLICATION DATA

This application claims the benefit of prior U.S. Provisional Application Ser. No. 61/654,419, filed Jun. 1, 2012, entitled “SYSTEM AND METHOD FOR DISTRIBUTED PATCH MANAGEMENT”, which is incorporated by reference herein in its entirety.

### BACKGROUND OF THE INVENTION

Effective vulnerability assessment and security patch management is critical to defend a computer network against malicious code, and is useful for other reasons, such as efficient update of software. Current networks detect and eradicate malicious code using a centralized repository and server. However, current malicious code, such as, worms and other malware, is able to infect machines by bypassing a centralized device using peer-to-peer transmissions. The malicious code propagates undetected through the computing network allowing the code to surreptitiously infect machines at a very rapid pace. Organizations may be unable to keep up with many of these malicious code outbreaks once they have penetrated their internal networks. Furthermore, if the centralized server suffers a system failure, any services rendered by that server may come to an abrupt end.

### BRIEF DESCRIPTION OF THE DRAWINGS

Specific embodiments of the present invention will be described with reference to the following drawings, wherein:

FIG. 1 is a schematic illustration of a system for providing patch management over a peer-to-peer network in accordance with an embodiment of the invention;

FIG. 2 is a schematic illustration of a coordinate space representing the logical location of network nodes in a peer-to-peer network in accordance with an embodiment of the invention;

FIG. 3 is an example of pseudo-code executed to re-route patches if a server node is infected in a peer-to-peer network in accordance with an embodiment of the invention; and

FIG. 4 is a flowchart of a method for providing patch management over a peer-to-peer network in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE INVENTION

A method and system for distributing patches to network nodes in a peer-to-peer network. A plurality of network nodes may be designated as “server” nodes. Each server node may be assigned to manage software patch distribution for a different zone, where each zone may include a different plurality of network nodes. Upon detecting a node in a zone to be a node in need of an update, a patch may be received from a patch source at the server node in the same zone as the node in need of the update. The patch may be transferred from the server node to the node in need of the update. The patch may be used to update the node in need of an update.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may provide peer-to-peer patch or software update management, designating the role of network security to the network's nodes. Patch management systems monitor network nodes (e.g., client devices) for code or software in need of an update and, if code in need of an update is found, distribute updates or patches to the nodes having the code or software to update their code and function. Instead of using a “top-down” approach distributing all patches directly from a centralized server, embodiments of the invention use a peer-to-peer approach, distributing patches from node-to-node through the network. Peer-to-peer or distributed patch management systems may detect and update code in need of an update at a faster pace than centralized servers, detect out-of-date or malicious code that circumvents centralized servers, and survive attacks even if a centralized server is infected or disabled by the out-of-date or malicious code. A node, code or software in need of an update may include a node, code or software which is infected with malware, which does not have the latest data or features (e.g., a font, map or functionality), or which is otherwise in need of a patch.

In a peer-to-peer patch management system, a subset of network nodes may be deemed or designated as “server” nodes, which may provide, at those nodes, patch management functionality, conventionally executed by a centralized server, to the remaining network nodes. Server nodes may provide a hybrid of centralized and peer-to-peer functionality. While each server node manages and thus is “central” to a group of nodes, each server node is still a node and thus acts as a non-centralized “peer” in a peer-to-peer environment. Patch management functionality, e.g., executed at server nodes, may include vulnerability assessment (detecting if a node has infected or out-of-date code), patch distribution (distributing patches to nodes in need of an update to update their code) and network security maintenance (running security checks to verify the identity of network members, the member's authorization to share data, and the security of distributed patches).

To assess vulnerability, each network node and/or the server node in its zone may test each network node for code in need of an update, for example, by searching for system components and/or applications in the network node that are missing an update and/or a patch. If node or its code in need of an update is detected or determined to exist, the server node may transmit one or more patches or updates to the network node to repair and restore the code function. If the node is infected with malicious code, the node may be quarantined from the network and may be unable to transmit data over the network, for example, until its code is repaired and verified.

Embodiments of the invention may distribute patches to nodes via server nodes as a peer-to-peer transmission. Patches may be distributed in two phases through a network structured as a two-level node hierarchy of server nodes and remaining network nodes. In the first phase, patches may be distributed from one or more source devices to the server nodes and, in the second phase, from the server nodes to the remaining network nodes. Server node may distribute patches in parallel. Extra levels of hierarchy and associated distribution phases may be added to increase the number of parallel distribution streams and speed of patch propagation, for example, if the network grows beyond a threshold size. This multi-phase distribution system may propagate patches throughout the multi-level node network in multiple parallel transmission streams, to increase the speed of patch distribution as compared to the single centralized patch transmission stream used in conventional systems.

In some embodiments, the network may be divided, grouped or partitioned into a plurality of zones or groups, each zone including a group or cluster of nodes. Each zone may have one server node (exactly) and one or more (e.g., tens, hundreds or even thousands of) network nodes. An optimization algorithm may be executed to determine the optimal partitioning of the network into zones and/or, in each zone, the optimal node to mark or designate as a server node, for example, that provides the fastest network traffic speed, i.e., the smallest overall “logical distance” between network nodes and thus, may provide the most efficient path for distributing patches throughout the network. It may be appreciated that since each zone is defined by a unique server node, assigning a server node to each group of network nodes may be equivalent to partitioning the network into zones. The assignment of server nodes to groups of network nodes may be recorded and stored, for example, in a database or distributed hash table, at each network node. Thus, to access a patch, a network node may perform a lookup operation on the distributed hash table to find its assigned server node in its assigned zone. Once found, the network node may request and download the patch directly from that server node. When the network node receives the patch, the network node may assemble the patch (e.g., if it is sent in multiple patch parts), check the security of the patch (via the server node), install and run the patch, update the software file with the patched code, test the patched code for proper function and any residual code in need of an update and update the software files in memory. The patch may overwrite parts or the entire file updated by the patch.

The designation of server nodes may be flexible, dynamic and resilient. For example, if a server node becomes infected or needs an update itself or otherwise cannot operate optimally and can no longer securely distribute patches or software updates to the nodes in its zone, the server node may be replaced with a new server node (a different node). The new server node for the zone may be selected according to the same optimization algorithm, e.g., to maximize overall traffic speed. The new server node may be another network node in the same zone, e.g., the zone node with the next fastest traffic speed, or, a server node from another zone, e.g., a “closest” or “adjacent” zone (e.g., logically adjacent) measured by its logical distance (transfer speed) to the adjacent zone's server node. In addition to dynamic server nodes, the partitioning of the network into zones may also be dynamic. In the example above, if the new server node in a first zone is a server node from a second adjacent zone, the first and second zones may be combined since they have the same server node. In another example, the optimization algorithm may be re-run to re-zone the network, e.g., each time a server node is infected or after a threshold number of nodes and/or server nodes are infected. The hash table or database may be updated to reflect the marking or designation of new server nodes and/or zones. In contrast, in conventional systems, if the centralized server is infected or inoperable, there may be no back-up security device and the security of the entire the network may be compromised.

Initially the server node within each zone or group may be designated or marked as a server node by for example a main server (e.g., a source server 108). In the event of a failure of a server or a need to change the server, a new designation may be created. For example zone member nodes may elect or otherwise choose the new server node for the zone in which they are located. Information regarding which nodes are server nodes for zones may be stored for example in a hash table which may be continually updated and distributed to all zone members.

Distributed patch or software update management may also improve patch management in heterogeneous network environments. In heterogeneous network environments, nodes may operate using a variety of configurations including different security levels, operating systems, network protocols, etc., each potentially requiring different patch management configurations. While support for such diversity may overwhelm a centralized server, peer-to-peer networks may partition the nodes based on their patch protocols into multiple homogenous zones. For example, the network, which may be heterogeneous as a whole, may be partitioned so that the nodes of each zone support a single homogenous environment, thereby each server node need only support patch management to update or patch devices according to its own configuration type.

The marking or designation of zones and server nodes may be centralized or non-centralized, for example, executed via an optimization algorithm at a centralized server or at any non-centralized network node or third party device. The sources of the patches (e.g., the patch or software update source) may be centralized or non-centralized, for example, distributed via the provider of the application that has been infected. The patch source may be a centralized server to which server nodes turn to receive the patches.

Managing security in a peer-to-peer network is notoriously difficult. Conventional systems rely on a centralized server to run all security checks in a controlled and trusted environment. On the one hand, using a centralized server to check the security of all peer-to-peer transmissions creates a bottleneck, restricting all peer-to-peer transmissions into a single centralized queue, thereby limiting the benefits of increased traffic speed in peer-to-peer transmissions. On the other hand, relinquishing control of network security away from the centralized server sacrifices its trusted environment for the less trusted environment of network member devices. Embodiments of the invention exploit the benefits of both centralized and peer-to-peer security models by running security checks at server nodes. To ensure the security environment is trusted and controlled, server nodes may undergo a thorough security screening process (e.g., by a centralized security device), and, since server nodes are distributed throughout the network, security checks may be executed by server nodes in parallel, thereby maintaining the fast speed of peer-to-peer transmissions. Security checks may include verifying the identity of network members, the member's authorization to share data, and the security of distributed patches. To verify the identity of a network node, the server node may be issued a key and/or index uniquely associated with each network node in its zone. To request entry into the network, a network node submits its key and the server node in the same zone may determine if their respective keys match for the node's index. If so, the network node may be added to the zone and the network. Otherwise, the network node may be rejected as a security risk.

A node in need of an update may be a node which e.g., does not have the latest software, fonts, etc., a node which has software which, due to events (e.g. malware development) or the advancement of knowledge is determined to have a security risk associated with its software, or a node otherwise in need of software update. Thus a node may be in need of update due to factors external to the node—e.g., advancements in software making the node software out of date, or advancements in malware requiring updates to security.

A patch may be a piece of software or code designed to update nodes in need of an update, for example, to fix problems with, or update a computer program or its supporting data. This may include for example fixing security vulnerabilities and other bugs, improving the usability or performance, updating a new version of a system or application, or adding new features (e.g., extra fonts to a word processing program, extra maps to a global positioning system (GPS), etc.). Patches are typically distributed to target systems and then installed on the systems, modifying or updating the target software. Patches may refer, for example, to program code adapted to fix a current problem or prevent a potential problem, such as, the infection of a computer device. Applying, running, using, or executing a patch, i.e., “patching,” may refer to any operation executed by a network node using the patch, e.g., including assembling the patch from two or more patch pieces (transmitted separately), verifying or requesting verification of the security of the patch, installing and running the patch, updating a software file with the patch, testing the updated software file for proper function and any residual code in need of an update and updating memory files with the updated software code or patch. In some embodiments, patches or other software may be distributed for purposes of defeating a malware attack, or protecting against malware. For example, patches which update software to improve the software may be distributed according to embodiments of the invention.

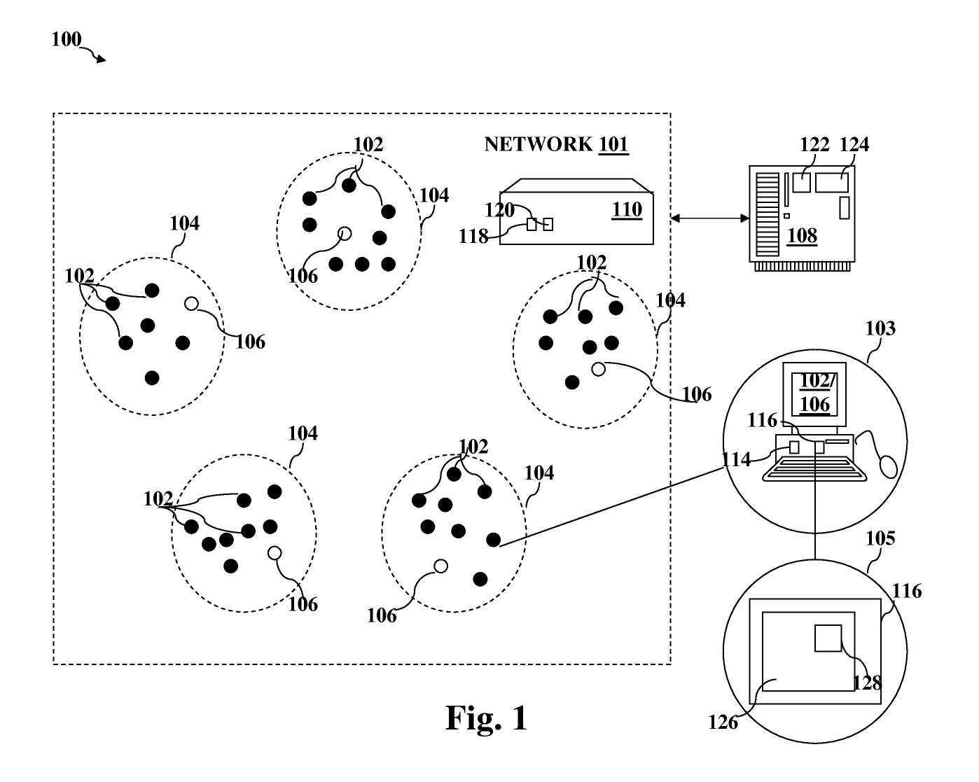

Reference is made to FIG. 1, which schematically illustrates a system 100 for providing peer-to-peer patch management over a network 101 in accordance with an embodiment of the invention. System 100 may be, for example, a distributed patch management security system (DPMSS).

Network 101 may be a peer-to-peer network, in which a plurality of network nodes 102 transmit data to each other. Each network node 102 may operate a client for peer-to-peer transmission, such as, a BitTorrent client. Patch management may also operate in network 101 via peer-to-peer transmission.

Network 101 may be grouped, partitioned or divided into a plurality of groups or zones 104, each zone 104 including a plurality of network nodes 102. In each zone 104, one of the network nodes 102 may be selected, marked or designated as a sever node 106 to provide patch management functionality and security maintenance to other nodes 102 in the same zone 104. The nodes selected to be sever node 106 may provide the fastest, among the nodes in the zone, overall or cumulative traffic speed to other network nodes 102 in their zone 104, for example, as determined via an optimization algorithm. A table or database (e.g., stored in a memory unit 116 and/or 120) may list the server node 106 designated for each network node 102 and/or for each zone 104. Thus, if network node 102 is determined to have software or code 126 in need an update, network node 102 may send a lookup request to the device storing the table, which returns the address or identification of a server node 106 associated with the requesting network node 102 or its zone 104. Network node 102 may request the update or patch 128 from the identified server node 106.

Patches 128 may be provided to network 101 via one or more source server(s) 108, e.g. a patch source, which may be the same (or different) server that provides the original code 126 in need of the update. If a network node 102 is determined to be vulnerable or infected, a patch 128 may be distributed to the infected node 102 in multiple phases. In a first phase, the sever node 106 designated in that group or zone 104 may receive a patch from source server 108, for example, either directly or via a network server 110. Source server 108 may provide a patch 128, for example, compatible with the type of update needed and/or any network and/or patch protocols associated with node 102, network 101 or zone 104. In a second phase, sever node 106 may then transmit patch 128 to the network node 102, for example, via a peer-to-peer client.

In some embodiments, network server 110 may manage network 101, for example, by partitioning network 101 into zones 104, designating server node 106 in each zone 104, hosting code to run patch management functionality at server nodes 106, distributing patches 128 to sever nodes 106 and/or screening server nodes 106 to ensure their security. Alternatively, no network server 110 may be used, network 101 may have no centralized devices and such functionality may be executed at one or more nodes or third party devices.

Network nodes 102 and server node 106 may be client devices such as, e.g., personal computers, desktop computers, workstations, mobile computers, laptop computers, cellular telephones, smart telephones, personal digital assistant (PDA), etc., and may include wired or wireless connections or modems. Each network node 102 and server node 106 may include one or more controller(s) or processor(s) 114 for executing operations and one or more memory unit 116 (as shown in close-up view 103) for storing data and/or instructions (e.g., software) executable by a processor including code in need of an update 126 and a patch 128 to update code 126 (as shown in close-up view 105). Network server 110 and source server 108 may also include one or more controller(s) or processor(s) 118 and 122 and one or more memory unit(s) 120 and 124, respectively. Processor(s) 114, 118 and/or 122 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 116, 120 and/or 124 may include, for example, a random access memory (RAM), a dynamic RAM (DRAM), a flash memory, a volatile memory, a non-volatile memory, a non-transitory memory, a cache memory, a buffer, a short term memory unit, a long term memory unit, or other suitable memory units or storage units. In one embodiment, each network node 102 and server node 106 may include a client for peer-to-peer communication and data transmission, such as, a BitTorrent client, which may be stored in memory unit 116 and run by processor 114.

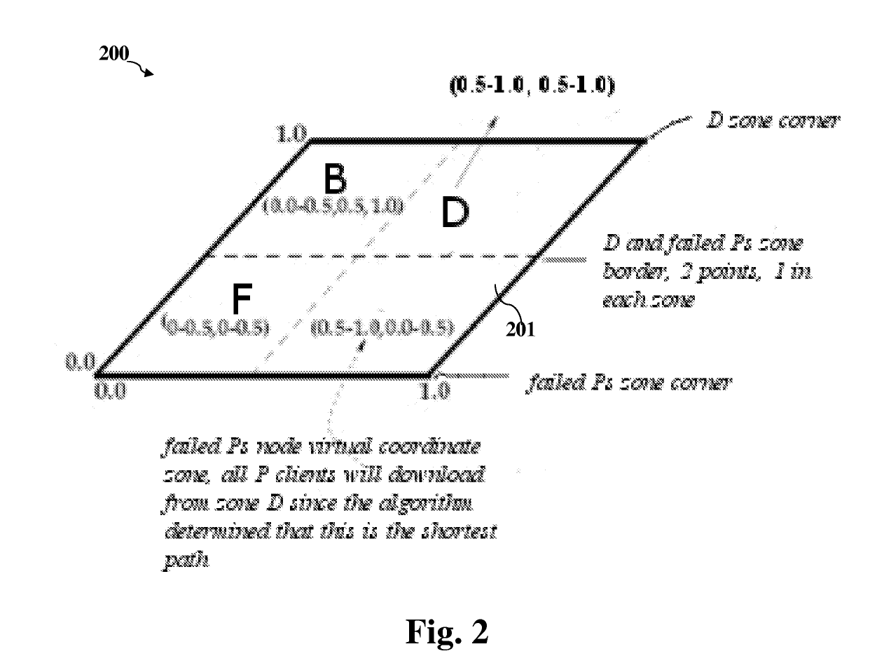

According to some embodiments of the invention, a distributed patch management system (e.g., system 100 of FIG. 1) may patch updates in large-scale file distribution networks (e.g., network 101 of FIG. 1). The network may be divided into groups or zones (e.g., zones 104 of FIG. 1), each zone having a plurality of (e.g., about ten in one embodiment, although other numbers may be used) network nodes (e.g., network nodes 102 of FIG. 1) per zone. Patches (e.g., patches 128 of FIG. 1) may be distributed in the network using distributed hash tables, a routing algorithm (e.g., to re-route patches if a server node is infected) and/or a distribution model (e.g., content addressable network (CAN) model, Chord model, Tapestry model, and/or Pastry model). The distribution model may index the network nodes as index points in a virtual coordinate space (e.g., coordinate space 200 of FIG. 2) measured by their logical distance (transfer speed) to other nodes. The network may be partitioned into zones by dividing the coordinate space into a plurality of regions and grouping the nodes into the same zone that have indices in the same region, e.g., as shown in Table 1. Since network nodes may be indexed based on their logical distance apart, nodes grouped into the same zone may have a below threshold logical distance and thus, fast traffic speeds therebetween. In the example of Table 1, a two-dimensional (2D) Cartesian coordinate space is divided into a grid of regular rectangular regions, although any other coordinate space or dimensionality may be used and the regions may be divided into any regular or irregular shape(s).

TABLE 1
Example Coordinate Space Partitioning into Regions Defining
Partitioning of Network Nodes into Zones

| | | | |
|---|---|---|---|
| E | A | G | |
| n1, n7, n11, | n17, n31, n45, | | |
| n24, n35 | n51, n54 | | |
| | | B | D |
| | | | n5, n12, n18, n43, |
| | | | 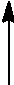 |
| | | | n81 |
| | C | F | |
| | n3, n9, n13, | n6, n44, n52, | n10, n18, n61, |
| | n55, n42 | n73, n94 | n74, n93 |

In the example of Table 1, the network is partitioned into groups or zones A-G and managed by server nodes A-G, respectively. Zones A, C, D, E and F each have five network nodes indicating that server nodes A, C, D, E and F provide the fastest traffic speed for the nodes in those respective zones. Thus, patches are distributed to each node ni via the server node A, C, D, E or F in that node's zone. Zones B and G have no network nodes indicating, for example, that server nodes B and G provide traffic speeds that are too slow for any nodes in the network. The zone associated with the bottom-left rectangle space has no server node, indicating, for example, that the zone's previous server node is disabled, for example, because it is infected by malicious code or is itself in need of an update. The arrow from this rectangle space indicates resilient zoning in which a new optimal server node is designated for this zone: server node D. Since both this zone and zone D have the same server node D, these zones may be merged to form a new zone D with ten network nodes.

In the patch distribution method, initially, one copy of the patch (e.g., patch 128 of FIG. 1) is transmitted from an application provider (e.g., source server 108 of FIG. 1) to the network, either directly to a server node (e.g., server node 106 of FIG. 1) or via a network server (e.g., network server 110 of FIG. 1). The patch may be obtained from the application provider by downloading it from the application provider's website or receiving it directly from the provider. The patch may then be distributed to the organization's computers in two phases. In the first phase, the patch is sent via the network to one designated node (e.g., server node 106 of FIG. 1) in each zone. In the second phase, the patch is further distributed via the network from the designated node to any node(s) (or all remaining nodes) in the zone in need of the update. This two-phased distribution process may increase the number of independent distribution paths for transferring or transmitting patches, e.g., compared with the single distribution path of the centralized approach, and thus, may increase the patch distribution speed as well as the system update or recovery speed.

Each server nodes may execute one or more of the following security checks using peer-to-peer transmission channels in each zone (other or different checks may be done):
(1) Verify the security of any new client node devices attempting to join the zone.
(2) Verify if network nodes are authorized to share data or patches in the peer-to-peer network and/or their types of sharing permissions (read/write vs. read-only permissions; a node security level authorized to share all data having a similar or lesser security level).
(3) Verify the integrity of patches before using them. In one example, a patch or patch file may be transmitted in multiple pieces and each piece may be authorized before it is assembled into a patch file and applied to patch a network node.

When a network node is authorized to join the network, the node may be issued a key, K, e.g., uniquely associated with a node in that network, and a “location” in the network defining its logical distance to other network nodes. The network node may be assigned an index in a coordinate space (e.g., vertex V(x,y) in a 2D Cartesian space) according to its location in the network. The network node may be indexed by applying a uniform hash function (e.g., SHA-1) to a distributed hash table that maps the unique key K to a unique index (e.g., vertex V(x,y)). A copy of the key K for each node may be stored at the network node (P) and another copy may be stored at the associated server node (Ps), for example, together with the node's index V(x,y), e.g., as a key-index pair (K,V), e.g., as shown in Table 2.

TABLE 2
Example Network Node (P) Key-Index Pairs and
Associated Zone/Server Nodes (Ps)
DPMSS Table

| Key (K) | Vertex (V) | P | IP Address | Zone (Ps) |
|---|---|---|---|---|
| c51ef5c5c8 | (1, 4) | n45 | 10.0.0.12 | A |
| d813424ef | (12, 5) | n5 | 10.0.1.24 | D |
| 54364ab69 | (20, 11) | n7 | 10.0.2.55 | E |
| 487e9b471 | (45, 22) | n31 | 10.0.10.60 | A |

To join the network (or start a new network session), the network node may send a request to its associated server node that includes the node's key K and index V. If the key-index pair (K,V) sent by the network node matches the key-index pair (K,V) stored in the server node, the server node may grant the network node permission to join the network and/or zone.

To retrieve patches from its associated server node, the same hash function (e.g., SHA-1) may be used to map the network node's key K to the server node, from which the patch may be retrieved. Server nodes may route patches using only information about network nodes in their respective zones (when the server node successfully provides a patch) and neighboring server nodes (to re-route patch distribution from a new server node in an adjacent zone, e.g., when the server node in the current zone is disabled). Since the logical coordinate space is a virtual coordinate grid, server nodes route packet transmissions along a path with the shortest logical distance, which may be, for example, a straight index line between the server node and network node in a zone.

Patches may be routed from server nodes to network nodes along a minimum distance path, e.g., between nodes having indices along a straight line through the coordinate space. For neighbor zones (e.g., occupying coordinate space regions that share a common edge), the distance from a network node to a server node may be computed from eight different points in coordinate space: four zone region corners and four middle points on each zone region border. For each network node indexed at a point along the path, the routing algorithm may compute the boundaries of each neighbor zone region to find a transmission path with the shortest distance to the server node.

Reference is made to FIG. 2, which schematically illustrates a coordinate space 200 representing a logical location (e.g., relative transfer speed) of network nodes (e.g., network nodes 102 of FIG. 1) in a peer-to-peer network (e.g., network 101 of FIG. 1) in accordance with an embodiment of the invention. FIG. 2 may represent the logical location of nodes, for example, as listed in Table 2.

Coordinate space 200 is divided into a plurality of (e.g., four) zone regions (e.g., B, D, F and an unnamed zone region in the lower left of the coordinate space) indexing zones B, D, and F, respectively. Zones B, D, and F each have a server node B, D, and F, respectively. For a network node in zones B, D, and F to attempt to retrieve a patch from the server node B, D, and F in its respective zone, the network node performs a lookup operation on the distributed hash table and finds that a server node exists in its zone and, since they are in the same zone, downloads the patch directly from the Ps node that owns that zone. All network nodes have a copy of the hash table with the coordinates of the zone's peers and the zone's neighboring zones' server nodes.

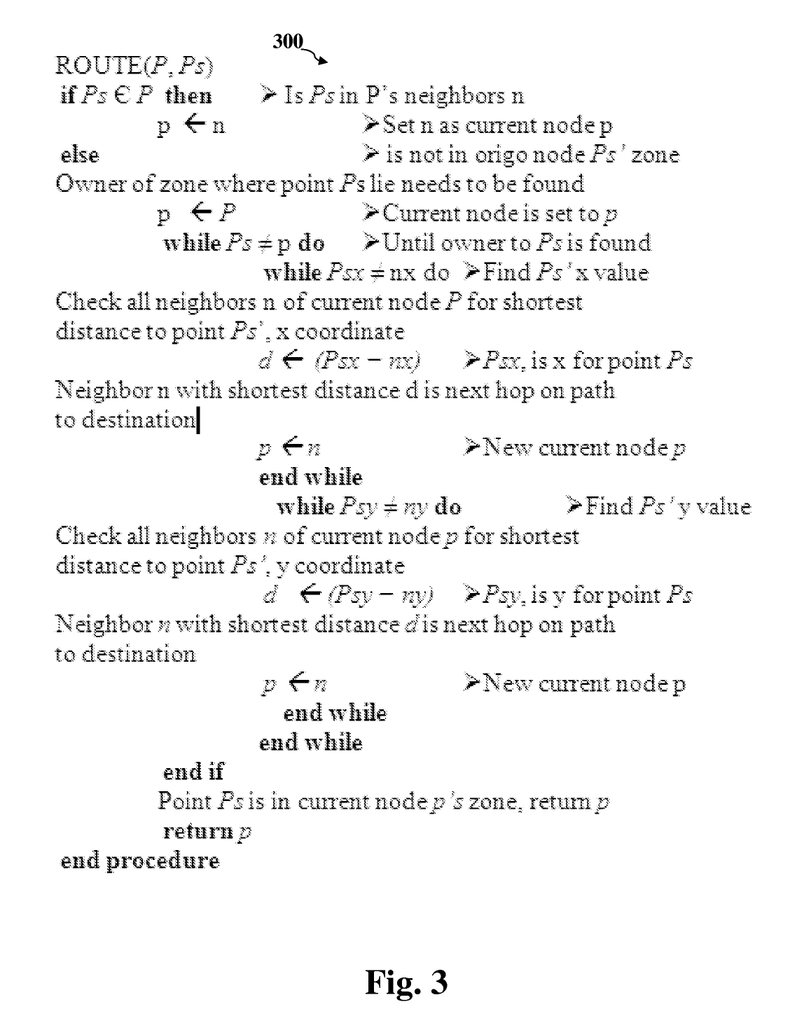

The designation of server nodes may be dynamic and changed, depending on the need or capabilities of the node devices. For example, a zone 201 may have a disabled or vulnerable server node (e.g., the server node does not transmit or produce the requested patches). Accordingly, a new server node may be designated (temporarily or permanently) to replace the disabled server node to transit patches to zone 201. The new server node may be selected, for example, that has the shortest logical distance to the network nodes in the infected zone 201. Thus, if a server node fails within zone 201, the network nodes in zone 201 may retrieve patches from the closest neighbor zone D that contains a server node D. A re-routing algorithm (e.g., defined by pseudo-code 300 of FIG. 3) determines the shortest path by calculating the extremities from the zone region corners (4 points) and the zone region borders (4 points) of the neighboring zone regions (D and F) and then moving along the x and y axes.

Reference is made to FIG. 3, which is an example of pseudo-code 300 executed to re-route patches, for example, if a server node is disabled in a peer-to-peer network, in accordance with an embodiment of the invention. In pseudo-code 300, the re-routing destination, i.e., the new server node, is determined by continuously evaluating the change in path length Δd value, while moving along the dimensions (x,y) of the coordinate space (e.g., coordinate space 200 of FIG. 2) until the shortest path is found. For a system with n nodes, O(log n) hops and a routing table having size O(log n) may be used. A virtual coordinate space may be partitioned into n equal zones that have a routing path length of d=(log2 n)/2. Other routing algorithms and pseudo-code may be used.

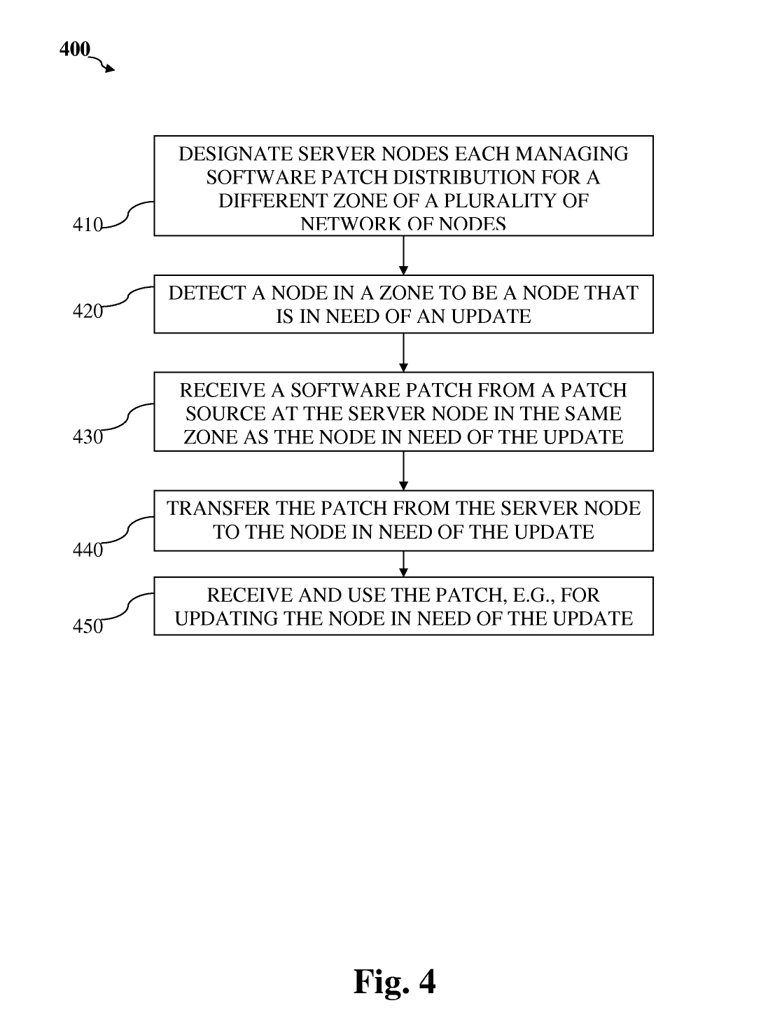

Reference is made to FIG. 4, which is a flowchart of a method 400 for providing peer-to-peer patch management over a network in accordance with an embodiment of the invention. Method 400 may be executed using network nodes 102 and server nodes 106 in system 100 of FIG. 1.

In operation 410, a processor (e.g., processor 118 of FIG. 1) may designate a plurality of network nodes (e.g., network nodes 102) as server nodes (e.g., server nodes 106 of FIG. 1). Each server node may be assigned to manage software patch distribution and/or security for a different zone (e.g., zone 104 of FIG. 1), each zone comprising a different plurality of network nodes. The correlation between network nodes, server nodes and zones may be stored in a distributed hash table (e.g., Table 2) in a memory unit (e.g., memory unit 116 of FIG. 1) in the network and/or server nodes.

In operation 420, a processor (e.g., processor 114 of network node 102 and/or server node 106 of FIG. 1) may detect or determine a node or its code to be in a zone to be in need of an update (e.g., a software or patch update), for example, by detecting that system components and/or applications in the network node are missing a requested or required update and/or patch. Upon detection of a node in need of an update, updating may take place.

In operation 430, a processor (e.g., processor 114 of server node 106 of FIG. 1) may receive or obtain, at the server node in the same zone as the node in need of an update, a patch or software update (e.g., patch 128 of FIG. 1) from a patch source (e.g., patch source 108 of FIG. 1).

In operation 440, a processor (e.g., processor 114 of server node 106 of FIG. 1) may transfer or transmit the patch from the server node to the vulnerable node. For example that patch may be sent or transmitted via conventional transfer methods over network 101.

In operation 450, the patch may be received or obtained and used or processed. E.g., the patch may be received by a network node, e.g., node 102. A processor (e.g., processor 114 of network node 102 of FIG. 1) may use the patch for updating the node in need of an update, which may include one or more of the following operations (or other or different operations): assembling the patch from two or more patch pieces separately sent or transmitted (if the patch is transmitted in different units), verifying or requesting verification of the security of the patch, installing and running the patch, updating a software file (e.g., software or code 126 of FIG. 1) with the patch, testing the updated software file for proper function and any residual malicious code and updating memory files with the updated software file. Other patch installation operations may be used.

Other operations of orders of operations may be used.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller (e.g., processor 114, 118, and/or 122 of FIG. 1), cause the processor or controller to carry out methods disclosed herein.

Various embodiments are discussed herein, with various features. However, not all features discussed herein must be in all embodiments. Furthermore, features of certain embodiments may be combined with features of other embodiments; thus certain embodiments may be combinations of features of multiple embodiments.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

1. A method for distributing patches to network nodes in a peer-to-peer network, the method comprising:
designating a plurality of network nodes as server nodes, each server node assigned to manage software patch distribution for a different zone, each zone comprising a different plurality of network nodes;
upon detecting a node in a zone to be a node in need of an update:
receiving a patch from a patch source at the server node in the same zone as the node in need of the update;
transferring the patch from the server node to the node in need of the update; and
using the patch to update the node in need of the update.

2. The method of claim 1 comprising executing an optimization algorithm to determine the optimal partitioning of the network into zones and the optimal node to designate as a server node in each zone.

3. The method of claim 2, wherein the optimal node in each zone has, compared to other nodes in the zone, the fastest overall traffic speed when exchanging information with the other network nodes in the zone.

4. The method of claim 1, comprising, if the server node in a zone does not transmit the patch, re-designating another node to be a new server node for the zone.

5. The method of claim 5, wherein the new server node is another network node in the same zone.

6. The method of claim 5, wherein the new server node is a server node in another logically adjacent zone.

7. The method of claim 1 comprising indexing each network node as a point in a coordinate space based on its logical distance to the other network nodes, wherein the network nodes are grouped into zones by dividing the coordinate space into a plurality of regions and grouping the nodes into the same zone that have indices in the same region.

8. The method of claim 1 comprising, for each network node:
assigning a key upon authorizing a network node to join the network;
associating the key with the index of the network node; and
comparing copies of the key stored at the network node and the server node that are associated with the network node index to authorize a network node, authenticate communication between nodes and coordinate the transferring of patches between nodes.

9. The method of claim 1, wherein the nodes are in a heterogeneous environment with multiple patch management protocols, and wherein the network of nodes is partitioned into a plurality of zones such that each zone supports a homogenous environment supporting a single patch management protocol at the server node.

10. The method of claim 1, wherein transferring comprises routing the patch from the server node to the network nodes along a path of minimum logical distance.

11. The method of claim 1, wherein said detecting a node in a zone to be a node in need of the update comprises determining that system components and/or applications in the node are missing a patch.

12. A peer-to-peer system for distributing patches, the system comprising:
a plurality of network nodes, a subset of which are designated as server nodes, each server node comprising a processor configured to manage software patch distribution for an associated plurality of network nodes forming a zone, wherein each server node manages a different plurality of network nodes forming a different zone from other server nodes; and
a memory storing the association of the server nodes with the network nodes, wherein, upon determination that a network node in a zone is a node in need of an update, the processor of the server node, which is associated with the network node in the memory, is configured to:
receive a patch from a patch source; and
transfer the patch from the server node to the network node in need of the update to update the network node using the patch.

13. The system of claim 12 comprising a network server to associate a server node with each zone of network nodes.

14. The system of claim 13, wherein the network server is to execute an optimization algorithm to determine the optimal server node to associate with the network nodes in each zone.

15. The system of claim 13, wherein the network server indexes each network node as a point in a coordinate space based on its logical distance to the other network nodes in the zone and divides the coordinate space into a plurality of regions and groups the nodes into the same zone that have indices in the same region of the coordinate space.

16. The system of claim 12, wherein, for each network node assigned a key and associated with an index, the processor of the server node associated with the network node is to compare copies of the key stored at the network node and the server node that are associated with the network node's index to authorize a network node to join the network, authenticate communication between nodes and coordinate the transfer of patches between nodes.

17. The system of claim 12, wherein, if the server node associated with a zone does not transmit the patch, the processor of a new server node transmits the patch.

18. The system of claim 17, wherein the new server node is another network node in the same zone.

19. A method for distributing a software update to network nodes, the method comprising:
if it is determined that a node in a zone needs a software update, each zone comprising a different plurality of network nodes, obtaining a software update at a server node in the same zone as the node in need of the update; and
transferring the software update from the server node to the node in need of the update.

20. The method of claim 19, wherein a plurality of network nodes are server nodes, each server node assigned to manage software update distribution for a different zone.
